(19) United States
(12) Patent Application Publication
(10) Pub. No.: US 2024/0298349 A1
(43) Pub. Date: Sep. 5, 2024

(54) TID TO LINK MAPPING FOR TDLS DIRECT LINK

(71) Applicants: SONY GROUP CORPORATION, Tokyo (JP); SONY CORPORATION OF AMERICA, New York, NY (US)

(72) Inventor: Qing Xia, San Jose, CA (US)

(73) Assignees: SONY GROUP CORPORATION, Tokyo (JP); SONY CORPORATION OF AMERICA, New York, NY (US)

(21) Appl. No.: 18/428,124

(22) Filed: Jan. 31, 2024

Related U.S. Application Data
(60) Provisional application No. 63/488,431, filed on Mar. 3, 2023.
(60) Provisional application No. 63/584,241, filed on Sep. 21, 2023.
(60) Provisional application No. 63/608,883, filed on Dec. 12, 2023.

(51) Int. Cl. H04W 74/0808; H04W 8/22; H04W 76/10; H04W 84/12

(52) U.S. Cl. CPC H04W 74/0808; H04W 8/22; H04W 76/10; H04W 84/12

(57) ABSTRACT

Present TID-to-link (T2L) mapping is limited in to only mapping the UL and/or DL direction. Mechanisms are taught for providing T2L mapping for TDLS link, while R-TWT features can be extended to setup R-TWT membership on a TDLS link. Using the T2L mapping for a TDLS link, different traffic with different priorities can be differentiated and directed on different TDLS direct links to reduce interference on any single link and to allocate the RTA traffic to channels which have wider bandwidths and less traffic congestion.

### CROSS-REFERENCE TO RELATED APPLICATIONS

This application claims priority to, and the benefit of, U.S. provisional patent application Ser. No. 63/488,431 filed on Mar. 3, 2023, incorporated herein by reference in its entirety. This application claims priority to, and the benefit of, U.S. provisional patent application Ser. No. 63/584,241 filed on Sep. 21, 2023, incorporated herein by reference in its entirety. This application claims priority to, and the benefit of, U.S. provisional patent application Ser. No. 63/608,883 filed on Dec. 12, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications when supporting peer-to-peer (P2P) transmission, and more particularly to an enhanced protocol for addressing associated communication issues.

### 2. Background Discussion

Current technology for a wireless communications supporting peer-to-peer (P2P) traffic communications has limited capability in regard to dividing different traffic of different TIDs to different forms of links and specifying traffic with specific TID(s) over single P2P direct link during an R-TWT SP.

Accordingly, a need exists for a communication apparatus and protocol which overcomes these Traffic Identifier (TID)-to-link mapping limitations and lack of TID specificity issues. The present disclosure fulfills that need and provides additional benefits over existing systems.

### BRIEF SUMMARY

An enhanced protocol is described for using Traffic Identifier (TID)-to-link (T2L) mapping schemes for Tunneled Direct Link Setup (TDLS) for a direct link. Using T2L mapping for TDLS links, R-TWT features are extended toward setting up R-TWT membership on a TDLS links. In addition, using T2L mapping for TDLS links, different traffic with different priorities can be communicated over different TDLS direct links to reduce the interference on single link and to allocate the RTA traffic to clearer and wider channel.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is topology diagram of a Basic Service Set being considered in the examples described according to at least one embodiment of the present disclosure.

FIG. 4 through FIG. 6 are communication diagrams of of single link TDLS direct link setup, according to at least one embodiment of the present disclosure.

FIG. 7 through FIG. 9 are communication diagrams of multi-link TDLS direct link setup, according to at least one embodiment of the present disclosure.

FIG. 10 through FIG. 12 are communication diagrams of negotiating during a multi-link TDLS direct link setup, according to at least one embodiment of the present disclosure.

FIG. 13 through FIG. 15 are communication diagrams of negotiating through a TDLS direct link after TDLS direct link setup, according to at least one embodiment of the present disclosure.

FIG. 16 and FIG. 17 is a communication diagram of setting up an R-TWT on a Peer-to-Peer (P2P) link, according to at least one embodiment of the present disclosure.

FIG. 18 is a flow diagram of processing a TDLS discovery/setup request received by the AP, according to at least one embodiment of the present disclosure.

FIG. 19 and FIG. 20 is a flow diagram of performing TID-to-link mapping by an initiator STA, according to at least one embodiment of the present disclosure.

FIG. 21 is a flow diagram of responding to a request frame by a P2P STA, according to at least one embodiment of the present disclosure.

FIG. 22 is a data field diagram of a TID-to-link control field format element within the T_D-to-Link mapping element of FIG. 21, according to at least one embodiment of the present disclosure.

FIG. 23 is a data field diagram of a TID-to-link mapping control field, according to at least one embodiment of the present disclosure.

FIG. 24 is a data field diagram of a Restricted TWT (R-TWT) traffic information field added to the R-TWT traffic information format of FIG. 23, according to at least one embodiment of the present disclosure.

FIG. 25 is a data field diagram of Traffic Information Control field as was shown in FIG. 24, according to at least one embodiment of the present disclosure.

### DETAILED DESCRIPTION

### 1. Conventional Wireless Communications

Present wireless communications uses a Traffic Identifier (TID) and TID-to-link (T2L) mapping which is limited to only Uplink (UL) and/or Downlink (DL) direction in the current draft P802.11be_D3.0. In the TID-To-Link Mapping element, the Direction subfield of TID-To-Link Control field is set to “0” if the TID-To-Link Mapping element provides the TID-to-link mapping information for frames transmitted on the downlink. It is set to a “1” if the TID-To-Link Mapping element provides the TID-to-link mapping information for frames transmitted on the uplink. This field is set to 2 if the TID-To-Link Mapping element provides the TID-to-link mapping information for frames transmitted both on the downlink and the uplink. The value of 3 is reserved.

Tunneled Direct Link Setup (TDLS) is characterized by encapsulating setup frames in Data frames, which allows them to be transmitted through an Access Point (AP) transparently. Stations (STAs) that set up a TDLS direct link remain associated with their Basic Service Set (BSS), but have the option of transmitting frames directly to the other TDLS peer STA. Transmitting a TDLS frame through the AP means that the Receiver Address (RA) of the frame is set to the Identification of the BSS (BSSID). Transmitting a frame (whether a TDLS frame or another frame) over the direct path means that the frame's RA is set to the Media Access Control (MAC) address of the TDLS peer STA. In the baseline IEEE 802.11 specification, the Link Identifier element contains information that identifies a TDLS direct link. The information utilized to identify a TDLS direct link includes the BSSID of the BSS of which the TDLS initiator STA is a member, the TDLS initiator STA's MAC address and the TDLS responder STA's MAC address. In draft P802.11be_D3.0, a link ID is defined as a numeric value that corresponds to a tuple (a tuple is an ordered sequence of values), in this case consisting of Operating Class, Operating Channel, and BSSID of the AP affiliated with the AP MLD, which applies for TDLS direct link ID.

R-TWT was introduced in 802.11be. An R-TWT scheduling AP is an EHT AP with dot11TWTOptionActivated equal to true that sets the Restricted TWT Support subfield in the transmitted Extra High Throughput (EHT) Capabilities element to ‘1’. An R-TWT scheduled STA is a non-AP EHT STA that sets the Restricted TWT Support subfield in the transmitted EHT Capabilities element to ‘1’ and sends to, or receives, from an R-TWT scheduling AP a broadcast TWT element carrying one or more Restricted TWT Parameter Set field(s). A non-AP EHT STA establishes membership for one or more R-TWT schedules with its associated EHT AP. An EHT AP that has dot11 RestrictedTWTOptionImplemented equal to true may announce one or more R-TWT SPs. The R-TWT SP is setup between R-TWT scheduling AP and R-TWT member non-AP STA(s) to serve certain Traffic Identifier(s) (TID(s)) that carry latency sensitive traffic in Uplink (UL) and/or Downlink (DL) for the R-TWT member. Thus, when a TID is not found, or no longer maps to a link on which the R-TWT membership is set up, the corresponding R-TWT membership is considered to have been torn-down.

### 2. Problem Statement

Conventional communications utilize Traffic Identifiers (TIDs) and provide TID-to-link (T2L) mapping for UL) and DL, however, there is not the capability for additional forms of mapping, such as for mapping a TID to a Tunneled Direct Link Setup (TDLS). Without T2L mapping to a TDLS direct link, it would be difficult to establish Reserved-Target Wait Time (R-TWT) membership on the TDLS direct link. Current R-TWT memberships can only be set up in a DL or a UL.

Without T2L mapping to TDLS direct link, it is not possible to direct different traffic with different priorities on different TDLS direct links, due to lack of T2L mapping capability when multi-link TDLS direct links are established between the TDLS direct link pair.

In the latest draft P802.11be_D5.0, there is no statement in the specification to prevent the triggered TXOP sharing procedure from occurring within an R-TWT SP. However, potential fairness issue arises if only the R-TWT TID(s) for UL and/or DL traffic is specified but not for P2P traffic, which is allocated to use the shared TXOP duration.

### 3. Contribution of the Present Disclosure

The present disclosure seeks to extend the R-TWT features to allow setting up R-TWT membership on TDLS links by providing a TID-to-link mapping scheme for a TDLS direct link. By providing T2L mapping for a TDLS link, different traffic can be distinguished with different priorities on different TDLS direct links to reduce interference on specific links and to allocate the RTA traffic to clearer and wider channels.

### 4. Hardware Embodiments

### 4.1. Communication Station (STA and MLD) Hardware

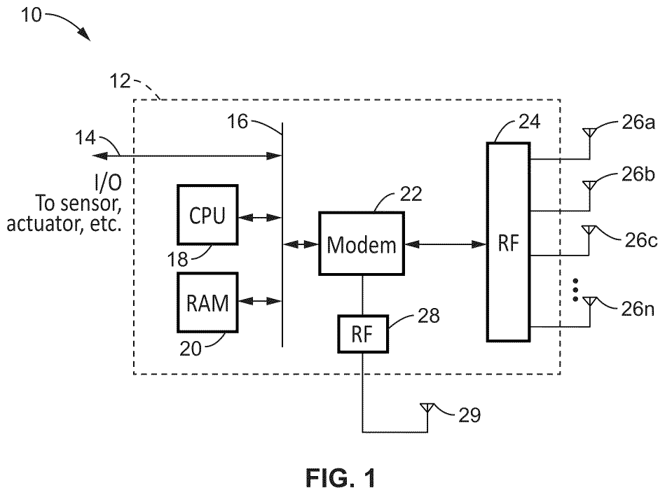

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

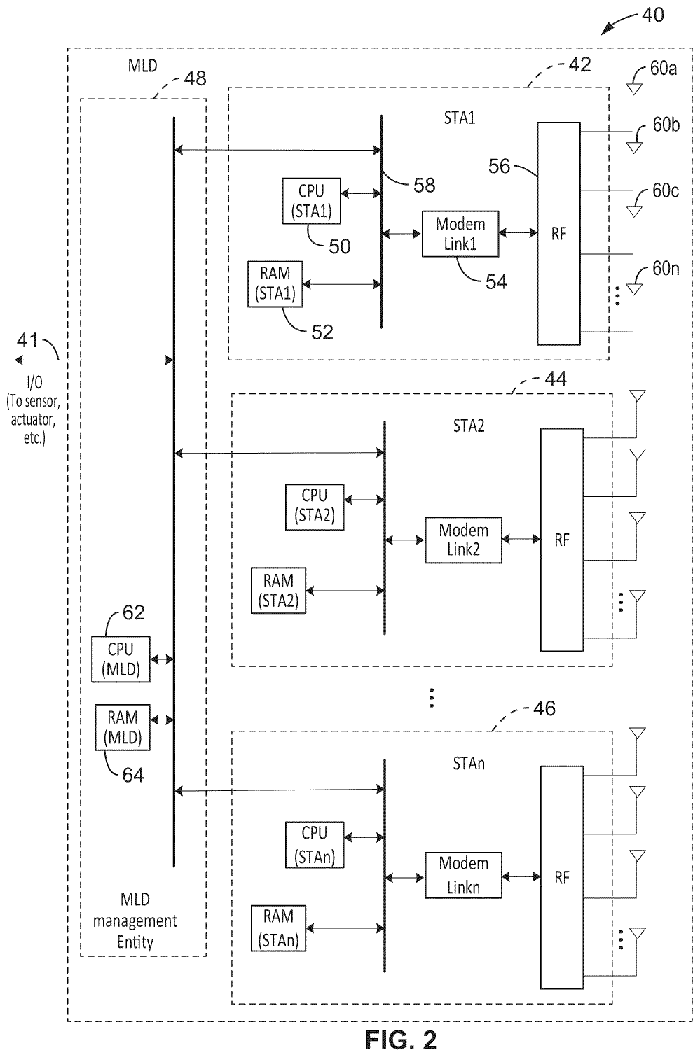

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHZ and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 5. Topology

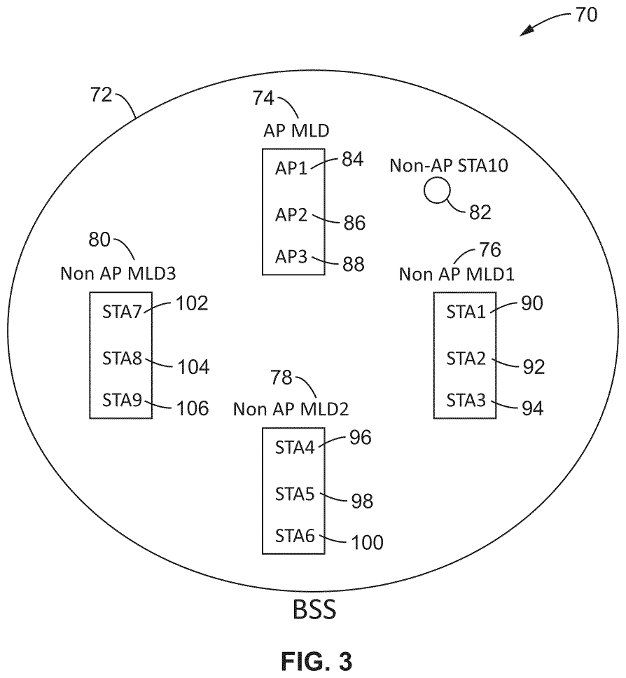

FIG. 3 illustrates an example STA/MLD topology utilized for the examples in the present disclosure. Unless otherwise specified, the examples in this disclosure are based on this topology. It should be appreciated that the present disclosure is not limited to any specific topologies, and that the topology in this figure is only provided for the purpose of simplifying discussions about the disclosed protocol enhancements.

The BSS under study consists of an AP MLD 74, a non-AP STA10 82 and 3 non-AP MLDs 76, 78 and 80. In this example the AP MLD 74 has three affiliated APs as AP1 84, AP2 86 and AP3 88, operating on link1 (L1), link2 (L2) and link3 (L3), respectively. Non-AP MLD1 76 has three affiliated STAs with STA1 90, STA2 92 and STA3 94, which operate on link1 (L1), link2 (L2) and link3 (L3), respectively. Non-AP MLD2 78 has three affiliated STAs with STA4 96, STA5 98, and STA6 100, which operate on link1 (L1), link2 (L2) and link3 (L3), respectively. Non-AP MLD3 80 has three affiliated STAs with STA7 102, STA8 104, and STA9 106, which operate on link1 (L1), link2 (L2) and link3 (L3), respectively. Non-AP STA10 82 operates on link1 (L1). STA1, STA4, STA7 and non-AP STA10 are associated with AP1. STA2, STA5 and STA8 are associated with AP2. STA3, STA6 and STA9 are associated with AP3.

### 6. TID-to-Link Mapping for TDLS/P2P Link(s)

If a TID is mapped to a set of enabled TDLS direct peer-to-peer (P2P) links between a non-AP MLD and its peer non-AP MLD, then the non-AP MLD may use any link within this set of enabled P2P links to transmit individually addressed MAC Service Data Units (MSDUs) or Aggregated MSDUs (A-MSDUs) that are destined (intended) to be sent to its peer non-AP MLD and that correspond to that TID. Under the default mapping mode, all TIDs are mapped to all setup links for DL and UL and P2P, and all setup links are enabled.

### 6.1. Negotiation of TID-to-Link Mapping for TDLS Direct Link(s)

In the present disclosure, two methods are described for negotiating TID-to-link mapping for TDLS direct link(s). These negotiations include negotiating during a TDLS direct link setup and negotiating after the TDLS direct link setup.

### 6.2. Negotiation During TDLS Direct Link Setup

The following describes the steps when setting up a single link TDLS direct link.

The initiation of the non-AP MLD should include TID-To-Link Mapping Negotiation Support and TID-to-Link mapping information in a TDLS Discovery request frame and/or TDLS Setup Request frame, or any other frames sent to the associated AP MLD or to P2P peer non-AP MLD during TDLS setup; such as described in Sections 9.2 and 9.4. The P2P peer non-AP MLD should include TID-To-Link Mapping Negotiation Support, Status Code and TID-to-Link mapping information in the TDLS Discovery response frame, and/or the TDLS Setup Response frame or any other frames sent to the associated AP MLD or to the mapping initiator non-AP MLD during the TDLS setup; such as described in Section 9.3 and 9.5. It should be appreciated that the TID-To-Link Mapping being established is only for the single TDLS direct link.

If multi-link TDLS direct links are being set up over a single link, then the following applies. The negotiating initiator EHT non-AP MLD should include TID-To-Link Mapping Negotiation Support and TID-to-Link mapping information in the TDLS Discovery request frame, and/or the TDLS Setup Request frame, or any other frames to be sent to the associated AP MLD or to the P2P peer non-AP MLD during the TDLS setup; such as defined in Section 9.2 and 9.4. The peer non-AP MLD should include TID-To-Link Mapping Negotiation Support, Status Code and TID-to-Link mapping information in the TDLS Discovery response frame, and/or TDLS Setup Response frame or any other necessary frames sent to the associated AP MLD or to the mapping initiator non-AP MLD during TDLS setup; such as defined in Section 9.3 and 9.5. It should be appreciated that in this instance the TID-To-Link Mapping is for the multi-link TDLS direct links.

### 6.2.1. Example Negotiations During Single Link TDLS Direct Link Setup

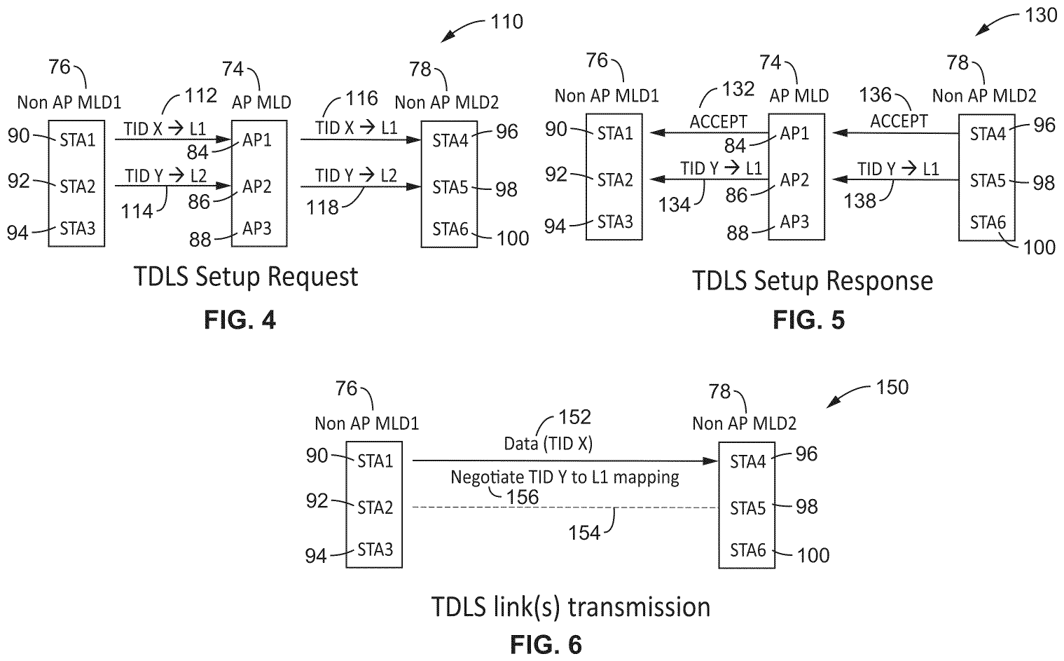

FIG. 4 through FIG. 6 illustrate an example embodiment 110, 130 and 150 of single link TDLS direct link setup. The figures depict communications between non-AP MLD1 76 having STA1 90, STA2 92 and STA3 94 with AP MLD 74 having AP1 84, AP2 86 and AP3 88, with non-AP MLD2 78 having STA4 96, STA5 98 and STA6 100.

In FIG. 4 during a TDLS Setup Request procedure, a TDLS setup request is performed on Link 1 (L1) and Link 2 (L2) independently. On L1, STA1 sends AP1 a TDLS Setup Request frame which carries information for a request to map 112 TID X to L1. AP1 receives the TDLS Setup Request frame from STA1 and forwards the received requesting information to STA4 in a TDLS Setup Request frame 116. On Link 2 (L2) STA2 sends AP2 a TDLS Setup Request frame which carries information of a request to map 114 TID Y to L2. AP1 receives the TDLS Setup Request frame from STA1 and forwards the received requesting information to STA5 in a TDLS Setup Request frame 118.

In FIG. 5 a TDLS Setup Response procedure is performed, with the TDLS setup responses being performed on L1 and L2 independently. On L1, STA4 responds to AP1 with a TDLS Setup Response frame which carries the information on accepting the requested mapping 136 of TID X to L1. AP1 receives the TDLS Setup Response frame from STA4 and forwards the received responding acceptance information 132 to STA1 in a TDLS Setup Response frame. On L2, STA5 responds to AP2 with a TDLS Setup Response frame which indicates that it prefers to map 138 TID Y to L1. AP2 receives the TDLS Setup Response frame from STA6 and forwards the received responding information 134 to STA2 in a TDLS Setup Response frame.

In FIG. 6 during the TDLS link(s) transmission, the transmissions are performed on L1 and L2 independently. On L1, since the TID X to L1 mapping has been established, STA1 transmits 152 Data of TID X to STA4 on L1. On L2, since the TID Y to L2 mapping cannot be established, there is no transmission 154 shown on L2 before TID Y to L2 mapping is established.

Back to L1, after TID-to-Link mapping negotiation result on L2 after transmission 134 is performed, STA1 may negotiate 156 a TID Y to L1 mapping with STA4, by exchanging the corresponding negotiation request and response information in TID-to-link Mapping Request frame and TID-to-link Mapping Response frame, respectively.

6.2.2. Example of Negotiation During Multi-Link TDLS Direct Link Setup (with all Mapping Accepted)

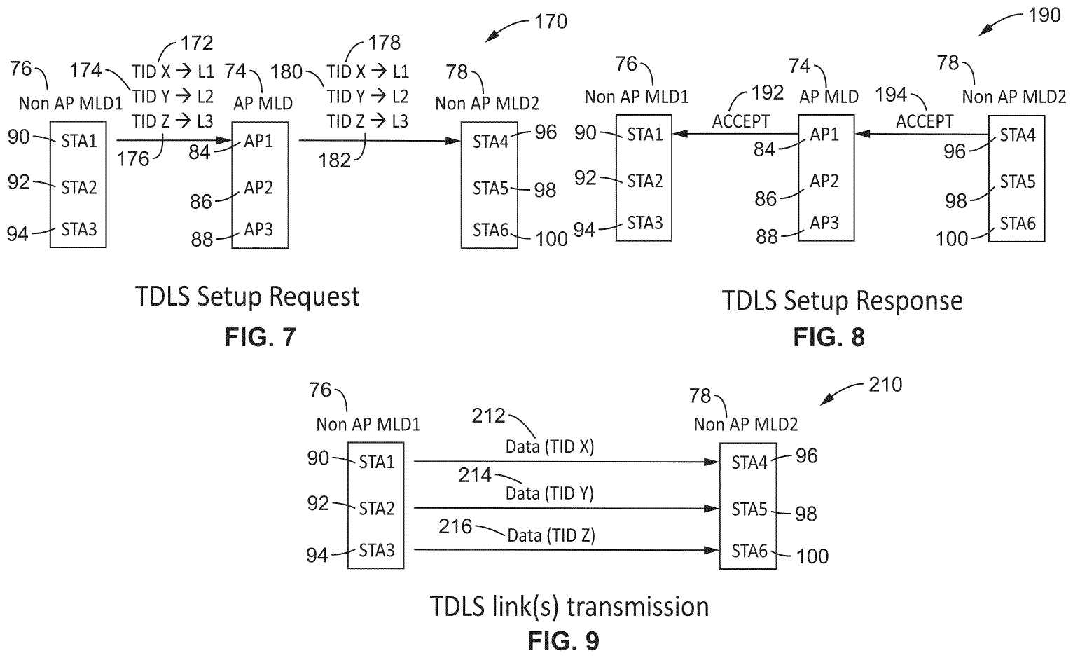

FIG. 7 through FIG. 9 illustrate examples 170, 190 and 210 of multi-link TDLS direct link setup for L1, L2 and L3 which can be negotiated over a single link, such as L1. The figures depict communications between non-AP MLD1 76 having STA1 90, STA2 92 and STA3 94 with AP MLD 74 having AP1 84, AP2 86 and AP3 88, with non-AP MLD2 78 having STA4 96, STA5 98 and STA6 100.

In FIG. 7 during a TDLS Setup Request procedure, TDLS setup requests are performed on L1. On L1, STA1 sends AP1 a TDLS Setup Request frame and carries information of a mapping request to map TID X to L1 172, map TID Y to L2 174 and map TID Z to L3 176. AP1 receives the TDLS Setup Request frame from STA1 and forwards the received requesting information 178, 180, 182 to STA4 in a TDLS Setup Request frame.

In FIG. 8 during TDLS Setup Response procedure, TDLS setup response is performed on L1. On L1, STA4 responds to AP1 with a TDLS Setup Response frame which carries information for accepting 194 the requested mapping of TID X to L1, TID Y to L2 and TID Z to L3. AP1 receives the TDLS Setup Response frame from STA4 and forwards the received responding information 192 to STA1 in a TDLS Setup Response frame.

In FIG. 9 in TDLS link(s) transmission, the transmissions are performed on L1, L2 and L3 independently. On L1, since the TID X to L1 mapping has been established, STA1 transmits Data 212 of TID X to STA4 on L1. On L2, since the TID Y to L2 mapping has been established, STA2 transmits Data 214 of TID Y to STA5 on L2. On L3, since the TID Z to L3 mapping has been established, STA3 transmits Data 216 of TID Z to STA6 on L3.

6.2.3. Example Negotiation During Multi-Link TDLS Direct Link Setup (with Partial Mapping Accepted)

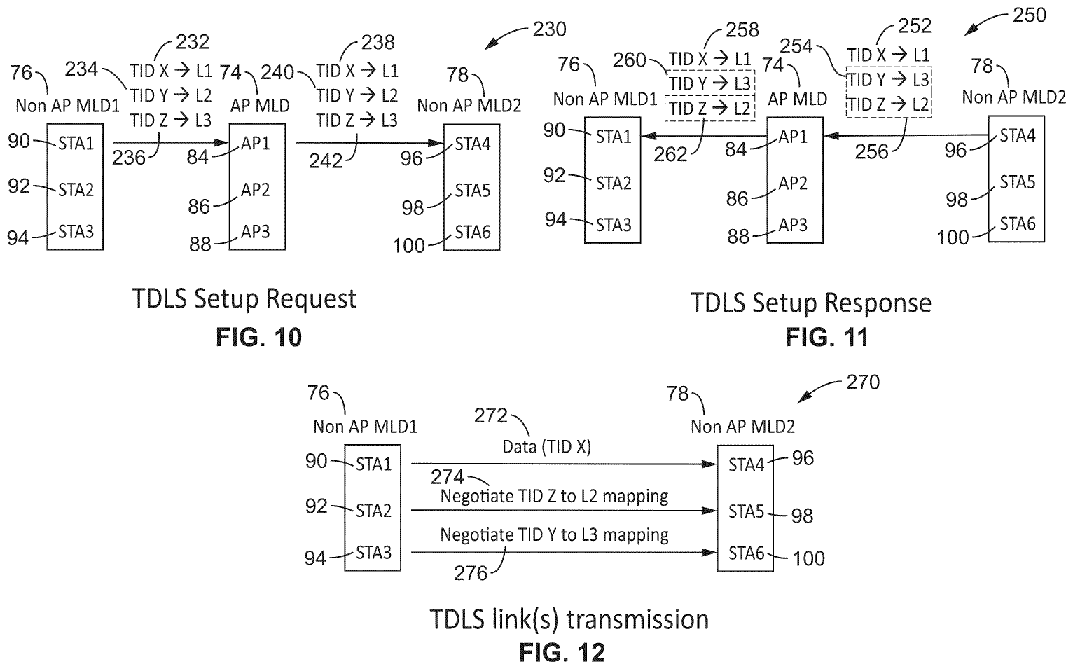

FIG. 10 through FIG. 12 illustrate examples 230, 250, 270 of multi-link TDLS direct link setup for L1, L2 and L3 could be negotiated over a single link, in this example L1. The figures depict communications between the non-AP MLD1 76 having STA1 90, STA2 92 and STA3 94 with AP MLD 74 having AP1 84, AP2 86 and AP3 88, with non-AP MLD2 78 having STA4 96, STA5 98 and STA6 100.

In FIG. 10 during a TDLS Setup Request procedure, TDLS setup requests are performed on L1. On L1, STA1 sends AP1 a TDLS Setup Request frame carrying information of a request to map 232 TID X to L1, map 234 TID Y to L2 and map 236 TID Z to L3. AP1 receives the TDLS Setup Request frame from STA1 and forwards the received requesting information 238, 240, 242 to STA4 in a TDLS Setup Request frame.

In FIG. 11 during the TDLS Setup Response procedure, TDLS setup responses are generated on L1 as STA4 responds to AP1 with a TDLS Setup Response frame carrying information in regard to accepting the requested mapping 252 of TID X to L1, and a preferred change to TID-to-Link mapping 254 of TID Y to L3 and different mapping 256 of TID Z to L2. AP1 receives the TDLS Setup Response frame from STA4 and forwards the received responding information 258, 260 and 262 to STA1 in a TDLS Setup Response frame.

In FIG. 12 during TDLS link(s) transmission, the transmissions are performed on L1, L2 and L3 independently. On L1, since the TID X to L1 mapping has been established, STA1 transmits 272 Data of TID X to STA4 on L1. On L2, since the TID Y to L2 mapping has not been established, STA2 shall not transmit Data of TID Y to STA5 on L2. Similarly, On L3, since the TID Z to L3 mapping has not been established, STA3 shall transmit Data of TID Z to STA6 on L3.

Based on the TID-to-Link mapping negotiation result on L1 after transmission 272 is performed then STA2 may negotiate 274 a TID Z to L2 mapping with STA5 by exchanging the corresponding negotiation request and response information in TID-to-link Mapping Request frame and TID-to-link Mapping Response frame, respectively. Similarly, Based on the TID-to-Link mapping negotiation result on L1 after the transmission 272 is performed then STA3 may negotiate 276 a TID Y to L3 mapping with STA6, by exchanging the corresponding negotiation request and response information in a TID-to-link Mapping Request frame and the TID-to-link Mapping Response frame, respectively.

6.3. Negotiate Using a TDLS Direct Link after TDLS Direct Link Setup

An initiating non-AP MLD that supports TID-to-link mapping shall send an individually addressed TID-to-link Mapping Request frame to a P2P peer non-AP MLD that has indicated support of TID-to-link mapping negotiation.

The exchange of supporting for TID-to-link mapping negotiation can be achieved during TDLS direct link setup, by including TID-To-Link Mapping Negotiation Support in TDLS Discovery request frame and TDLS Discovery response frame.

The P2P peer non-AP MLD shall send an individually addressed TID-to-link Mapping Response frame to the negotiating initiator non-AP STA MLD which includes an indication as to whether it will accept the requested TID-to-link mapping in the TID-to-link Mapping element in the received TID-to-link Mapping Request frame, or that it rejects the proposed TID-to-link mapping, or that it is suggesting a preferred mapping which is different from the requested TID-to-link mapping in the TID-to-link Mapping element in the received TID-to-link Mapping Request frame.

The negotiating initiator non-AP STA MLD should take into account (consider) the preferred TID-to-link mapping of the peer MLD. When two non-AP MLDs have negotiated a TID-to-link mapping, in which either MLD may tear down the negotiated P2P TID-to-link mapping by sending an individually addressed TID-To-Link Mapping Teardown frame. After teardown, these MLDs shall operate in the default mapping mode.

6.3.1. Example Negotiate Via a TDLS Direct Link after TDLS Direct Link Setup

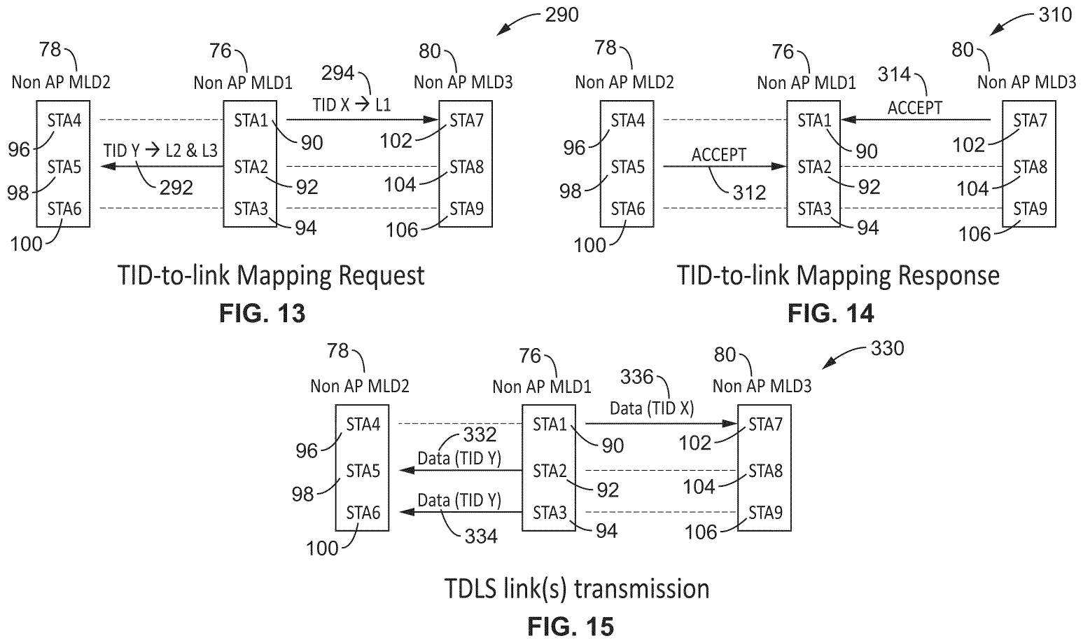

FIG. 13 through FIG. 15 illustrates examples 290, 310, and 330 of multi-link TDLS direct link setup for L1, L2 and L3 being established between non-AP MLD1 and non-AP MLD2, and between non-AP MLD1 and non-AP MLD3. The figures depict communications between non-AP MLD1 76 having STA1 90, STA2 92 and STA3 94 with non-AP MLD2 78 having STA4 96, STA5 98 and STA6 100, with non-AP MLD3 80 having STA7 102, STA8 104 and STA9 106.

In FIG. 13 during a TID-to-link Mapping Request procedure, TID-to-link mapping requests are sent on L1 and L2 independently. On L1, STA1 sends STA7 a TID-to-Link Mapping Request frame carrying information of a request to map 294 TID X to L1. On L2, STA2 sends STA5 a TID-to-Link Mapping Request frame with carrying information of a request to map 292 TID Y to L2 and map TID Y to L3.

In FIG. 14 during a TID-to-link Mapping Response procedure, the TID-to-link Mapping Responses are seen being performed on L1 and L2 independently. On L1, STA7 responds to STA1 with a TID-to-link Mapping Response frame carrying information on the acceptance 314 of the requested mapping of TID X to L1. On L2, STA5 responds to STA2 with a TID-to-link Mapping Response frame carrying information in regard to accepting 312 the requested mapping of TID Y to L2 and TID Y to L3.

In FIG. 15 during TDLS link(s) transmission, the transmissions are performed on L1, L2 and L3 independently. On L1, since the TID X to L1 mapping has been established, STA1 transmits 336 Data of TID X to STA7 on L1. On L2, since the TID Y to L2 mapping has been established, STA2 transmits Data 332 of TID Y to STA5 on L2. On L3, since the TID Y to L3 mapping has been established, STA3 transmits 334 Data of TID Y to STA6 on L2.

### 7. Setting Up P2P Links

### 7.1. R-TWT Setup on P2P Link

Using the TID-to-link mapping on multi-link TDLS/P2P links, the R-TWT may also set up P2P links using an embodiment which incorporates the following. A Restricted TWT P2P TID Bitmap field is added to the Restricted TWT Traffic Info field as defined in Section 9.6 TWT Element. In addition, a P2P TID Bitmap Valid subfield is added to the Traffic Info Control field as defined in Section 9.6 TWT element.

The R-TWT requesting STA sends a R-TWT request frame to the associated AP and indicates the R-TWT is for a certain TID(s) on an established P2P link with P2P peer STA. The TID(s) as negotiated for R-TWT shall be contained by the TID(s) mapped to that P2P link.

The R-TWT scheduling AP may send an unsolicited R-TWT response frame to the P2P peer STA to pass the R-TWT requested/suggested schedule from the R-TWT requesting STA.

The peer STA which receives the unsolicited R-TWT response frame may accept the requested/suggested schedule by responding with a R-TWT response frame which indicates acceptance of the schedule; or the peer STA may continue R-TWT negotiation with the R-TWT scheduling AP by transmitting a R-TWT response frame indicating a different set of R-TWT parameters; or the peer STA may reject the requested/suggested schedule by responding with a R-TWT response frame indicating a rejection of the schedule.

The R-TWT scheduling AP should transfer (forward) the response from the peer STA to the R-TWT requesting STA. The R-TWT requesting STA can then update the negotiated R-TWT parameters based on the response received from the R-TWT scheduling AP.

During the R-TWT SP on the P2P link, it is possible that both R-TWT requesting STA and its P2P peer STA are considered as R-TWT member STAs and could transmit the P2P traffic with the R-TWT TID to each other. It is also possible that only the R-TWT requesting STA is considered as the R-TWT member STA and can transmit the P2P traffic with the R-TWT TID to the P2P peer STA.

In draft P802.11REVme_D3.0, the TDLS Setup Request frame and TDLS Setup Response frame can contain the information of the TWT element. However, the TWT element is not a broadcast TWT element given the limitation “The Trigger subfield and the Negotiation Type subfield of the TWT element are set to 0” as defined in Table 9-499 of Information for TDLS Setup Request Action field in draft P802.11REVme_D3.0. It should be appreciated that the TDLS Setup Request frame and TDLS Setup Response frame can be configured to carry information of a TWT element in which the Negotiation Type subfield of the TWT element are set to a value of ‘2’ and/or ‘3’, to indicate that the TWT element provides a broadcast TWT schedule in broadcast or individually addressed Management frames, respectively. Otherwise, in at least one embodiment, the TDLS Setup Request frame and TDLS Response frame can be configured to also contain the information of the TWT element of R-TWT with the TWT element proposed in 9.6 TWT element in the present disclosure. In this case, R-TWT on P2P link can also be setup during TDLS link setup stage, through the exchange of TDLS Setup Request frame and TDLS Setup Response frames.

The P2P peer STAs that established the R-TWT SP for any P2P transmission as mentioned in this section shall adhere to (follow) the value(s) as indicated in the P2P TID Bitmap Valid subfield and the Restricted TWT Traffic Info field as described in Section 9.6 in this disclosure.

7.1.1. Example of R-TWT Setup on P2P link

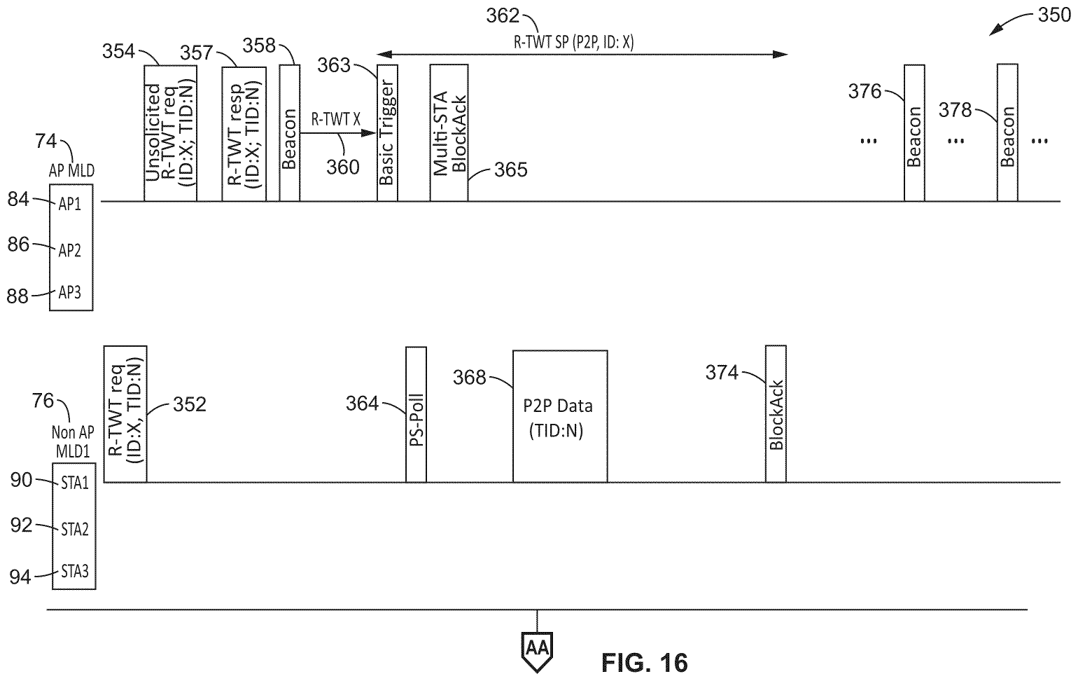

FIG. 16 and FIG. 17 illustrate an example embodiment 350 of an R-TWT setup on a P2P link. Communications are seen to and from AP MLD 74 having AP1 84, AP2 86 and AP3 88, non-AP MLD1 76 having STA1 90, STA2 92 and STA3 94, and non-AP MLD3 having STA4 96, STA5 98 and STA6 100.

STA1 sends a R-TWT request frame 352 to AP1 to suggest/request setup of a R-TWT SP with ID:X, on a P2P link that has been setup between STA1 and STA4. The requested R-TWT SP is for P2P traffic with TID:N.

After AP1 receives the R-TWT request frame from STA1, AP1 sends 354 to STA4 an unsolicited R-TWT response, with a R-TWT Setup Command field that indicates to Accept the R-TWT, and it allocates a R-TWT (ID:X) schedule as requested by STA1 to STA4.

STA4 receives the unsolicited R-TWT response from AP1 with a R-TWT Setup Command field that indicates to Accept the TWT. STA4 then transmits a R-TWT response 356 with TWT Setup Command field indicating Accept TWT to accept the R-TWT (ID:X) schedule as requested by STA1.

AP1 receives 357 the R-TWT response frame from STA4 which transmitted the R-TWT response frame to STA1 with a TWT Setup Command field that indicates Accept R-TWT.

AP1 broadcasts a Beacon frame 358 carrying an R-TWT element 360 to indicate R-TWT SP(ID:X). STA1 and STA4 awake to receive the Beacon frame to determine R-TWT(ID:X). During the R-TWT (ID:X), AP transmits a basic trigger frame 363 to STA1 and STA4. STA1 indicates that it is awake by sending a PS-Poll 364, and STA2 indicates that it is awake by sending a QOS Null frame 366 in response to the Basic Trigger frame. In response to the polls, AP1 sends a multiple-STA block acknowledgement (multi-STA Block Ack) 365.

Within the R-TWT (ID:X) 362, STA1 transmits the P2P traffic 368 with TID:N to STA4 and receives BlockAck 370 frame from STA4. Then STA4 transmits the P2P traffic 372 with TID:N to STA1 and receives BlockAck frame 374 from STA1. Additionally, ongoing beacons are shown from AP1 376, 378.

### 7.2. Triggered TXOP Sharing Procedure Enabled P2P Transmission Inside R-TWT SP

In the following, two embodiments are described for the R-TWT scheduling AP and the R-TWT scheduled STAs that support the R-TWT feature and the Triggered TXOP sharing feature.

In a first embodiment either the R-TWT scheduling AP or the R-TWT scheduled STA should specify that the triggered TXOP sharing enabled P2P transmission is not allowed inside the negotiated R-TWT SP. In this case, the Restricted TWT Traffic Info field format and Traffic Info Control field format should reuse the frame format as designed in draft 802.11be D5.0.

In a second embodiment either the R-TWT scheduling AP or the R-TWT scheduled STA should specify that the TXOP sharing enabled P2P transmission is allowed inside the negotiated R-TWT SP. In this case, the Restricted TWT Traffic Info field format and Traffic Info Control field format should be designed as introduced in Sec. 9.6.

The capability of whether to allow the Triggered TXOP sharing enabled P2P transmission inside an R-TWT SP, or not, can be specified by an attribute, e.g., dot11TXOPSharingEnabledP2PInRtwt. If this attribute value is set to true, then the STA shall support P2P transmission enabled by the triggered TXOP sharing procedure inside an R-TWT SP. If this attribute is set to false, then the STA doesn't support P2P transmission enabled by the triggered TXOP sharing inside an R-TWT SP. If there is not such an attribute specified, then by default it can be assumed that the STA supports P2P transmission enabled by the triggered TXOP sharing procedure inside an R-TWT SP.

The capability attribute value of “dot11TXOPSharing EnabledP2PInRtwt” as defined above can be specified at any stage before the R-TWT SP starts and/or before the triggered TXOP sharing procedure starts.

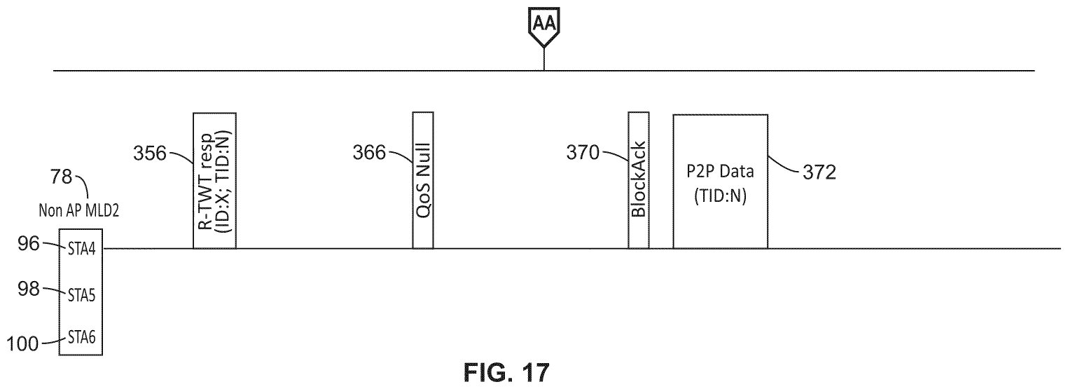

FIG. 18 illustrates an example embodiment 410 of an AP receiving a TDLS discovery or setup request. Check 412 determines if a Discovery/Setup Request frame has been received which carries TID-to-Link Mapping request information. If the condition is not met, then processing ends. Otherwise, execution reaches block 414 and the TID-to-Link mapping request information is sent to the P2P peer STA by using a TDLS Discovery/Setup Request Frame.

### 8. Flow Diagrams

Then at check 416 it is determined if the AP has received a TDLS Discovery/Setup Response frame carrying TID-to-Link mapping response information. If the frame has not been received, then at block 418 it waits for the response before repeating check 416 (for simplicity of illustration timeout logic is not shown).

If the condition is met, then at block 420 the AP forwards the TID-to-Link mapping response information to a TID-to-Link mapping initiator STA within a TDLS Discovery/Setup Request frame, and then processing ends.

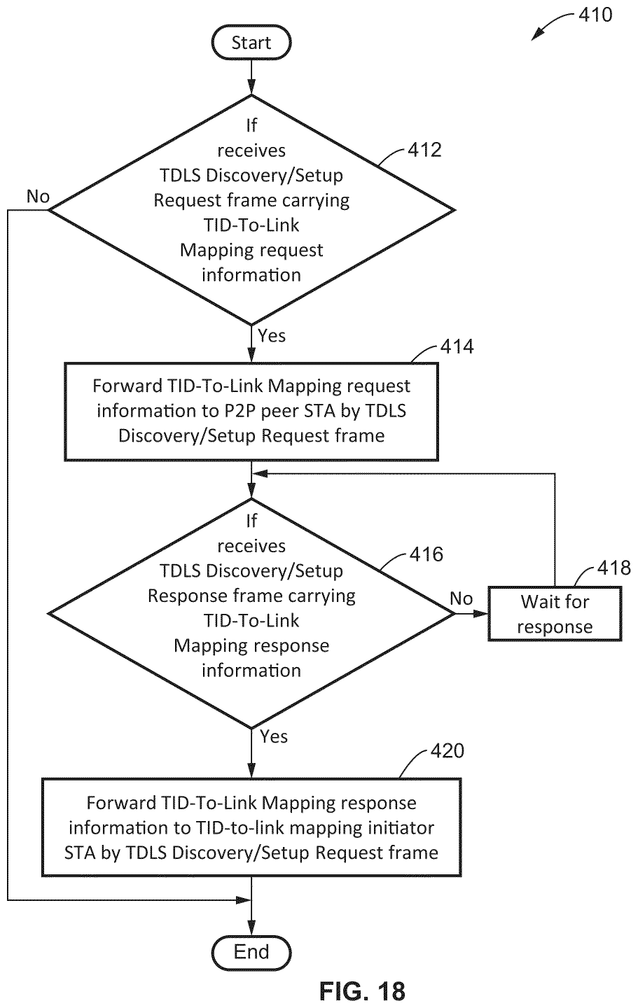

FIG. 19 and FIG. 20 illustrate an example embodiment 450 of TID-to-link mapping for an initiator STA. Check 452 determines if the TDLS setup has been established. If it has not been established, then at block 454 the requester carries TID-to-Link mapping request information within a TDLS Discovery/Setup request frame in a communication addressed to the associated AP.

Then check 456 determines if a TDLS discovery/setup frame has been received which contains information that the P2P peer STA has accepted the TID-to-Link mapping request information. If the condition is not met, then at block 458 a TID-to-link mapping request frame is sent to the P2P peer STA on the P2P link, then execution moves to check 462 in FIG. 20.

Check 462 determines if it has received a TID-to-link mapping response frame indicating that the P2P peer STA has accepted the TID-to-link mapping request information. If the condition is met, then at block 460 TID-to-link mapping is established, and processing ends.

Otherwise, if the condition is not met, then at check 464 it is determined if the initiator STA should continue TID-to-link mapping negotiation. If the condition is not met, then processing ends. Otherwise, execution moves to block 458 in FIG. 19 which was already described.

Considering check 456 in FIG. 19, if the condition is met, then execution moves to block 460 in FIG. 20 in which TID-to-link mapping is established, after which processing ends.

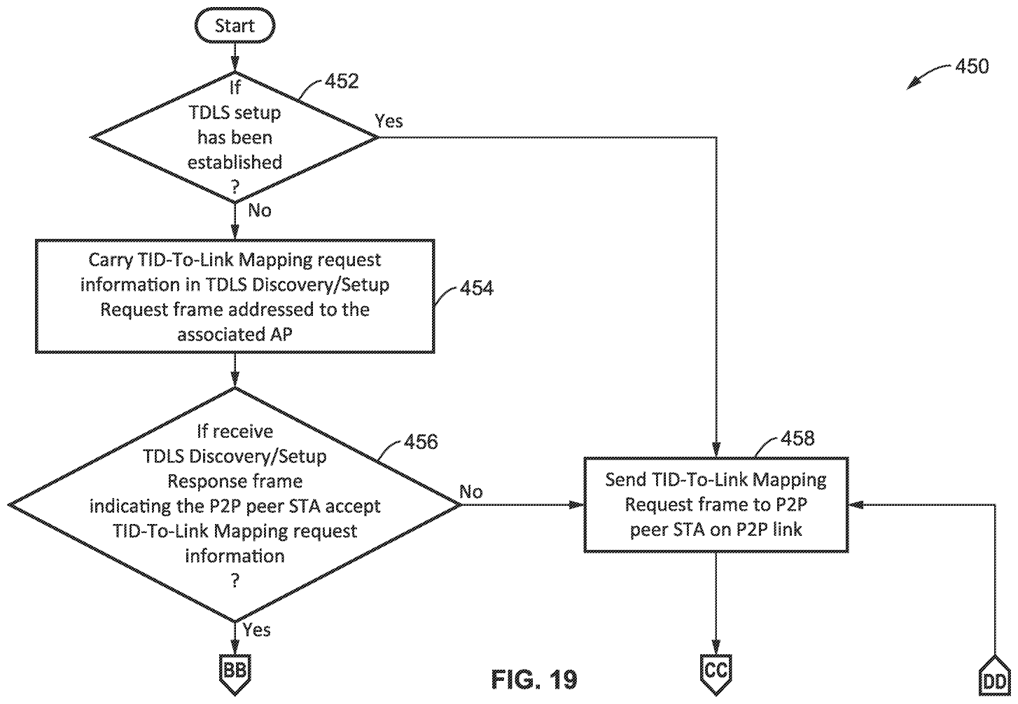

FIG. 21 illustrates an example embodiment 490 of operations performed by a P2P peer STA. Check 492 determines if a TDLS setup has been established. If it has been established, then processing ends. Otherwise, check 494 determines if a TDLS discovery/setup request frame has been received indicating TID-to-link mapping request information for the P2P link.

If it has been received, then at block 496 the P2P STA responds with TID-to-link mapping response information in a TDLS discovery/setup response frame sent to the AP, and the process ends. Otherwise, check 498 determines if a TID-to-link mapping request frame has been received which indicates the TID-to-link mapping request information on the P2P link. If the condition is not met, then the process ends. Otherwise, at block 500 the P2P STA responds by sending TID-to-link mapping response information in a TID-to-link mapping response frame to the TID-to-link mapping initiator STA, before processing ends.

### 9. Frame Formats

### 9.1 TID-to-Link Mapping Element

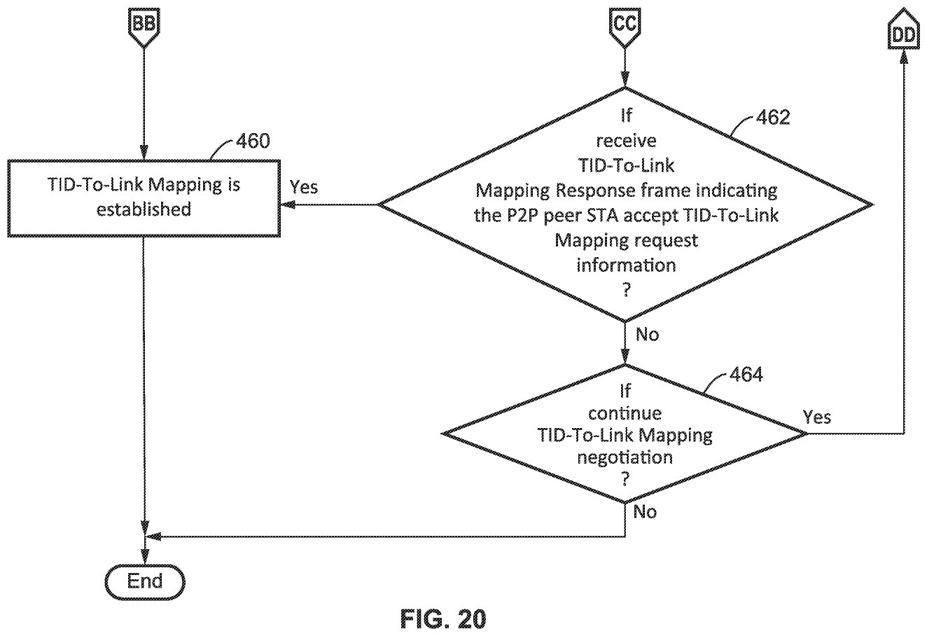

FIG. 22 illustrates a TID-to-link mapping element 510 containing the following fields: Element ID, Length, Element ID Extension, TID-to-link Mapping Control, Mapping Switch Time, Expected Duration, optional Link Mapping of TIDs, depicted for TID 0 through to TID 7, shown by way of example and not limitation.

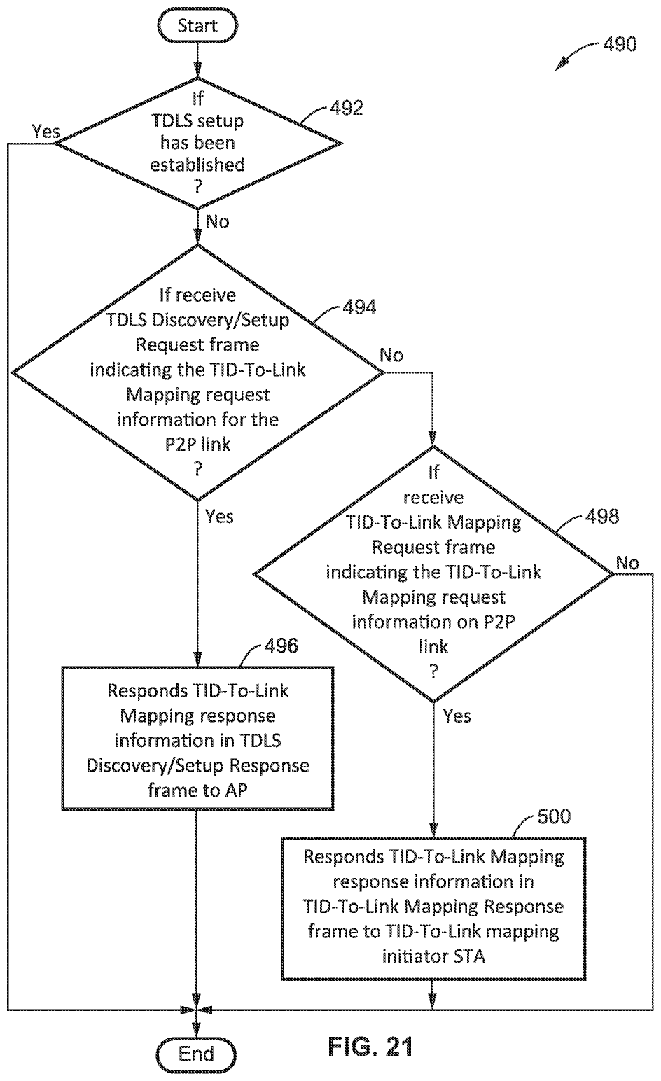

FIG. 23 illustrates the contents of the TID-to-link mapping control field shown in FIG. 22, having the following subfields: Direction, Default Link Mapping, Mapping Switch Time Present, Expected Duration Present, Link Mapping Size, reserved, and an (optional) Link Mapping Presence Indicator.

Setting the Direction subfield of the TID-To-Link Control field of the TID-To-Link Mapping element to a value, e.g., ‘3’, indicates that the TID-To-Link Mapping element provides the TID-to-link mapping information for frames transmitted on the TDLS direct links. The other fields are same as that defined in the draft P802.11REVme_D3.0 specification.

It should be noted that in the TID-To-Link Mapping element, the optional Link Mapping of TID n field (where n=0, 1, . . . , 7) indicates the link(s) on which frames belonging to TID n are allowed to be sent. A value of ‘1’ in bit position i (where i=0, 1, . . . , 14) of the Link Mapping Of TID n field indicates that TID n is mapped to the link associated with the link ID i for the direction as specified in the Direction subfield. A value of ‘0’ in bit position i indicates that the TID n is not mapped to the link associated with the link ID i. When the Default Link Mapping subfield is set to ‘1’, this field is not present.

It should be noted that the Link ID of the TDLS link is utilized to provide link ID information in the Link Mapping of TID n field of the TID-To-Link Mapping element. Based on Draft P802.11be_D3.0, a link ID is defined as a numeric value that corresponds to a tuple consisting of Operating Class, Operating Channel, and BSSID of the AP affiliated with the AP MLD.

### 9.2 TDLS Discovery Request Frame

Table 1 depicts information for a TDLS Discovery Request Action field. The new rows are inserted into the TDLS Discovery Request Action field table. The TID-To-Link Mapping Negotiation Support field indicates what the STA that sent this frame supports for TID-to-link mapping negotiation. The TID-to-link mapping field contains a TID-to-link Mapping element that indicates TDLS direct links on which frames belonging to each TID can be exchanged.

### 9.3 TDLS Discovery Response Frame

Table 2 depicts information for a TDLS Discovery Response Action field. The new rows are inserted into TDLS Discovery Response Action field table. The TID-To-Link Mapping Negotiation Support indicates that the STA has sent information in this frame to support TID-to-link mapping negotiation. The Status Code is used to indicate the requested TID-to-Link mapping information as carried in the received TDLS Discovery request frame addressed to the receiver is accepted, or rejected, or suggested with a preferred mapping by the receiver. The TID-to-Link mapping information field contains a TID-to-link Mapping element that indicates the preferred mapping on the TDLS direct link.

### 9.4 TDLS Setup Request Frame

Table 3 depicts information for a TDLS Setup Request Action field. New rows are inserted into a TDLS Setup Request Action field. The TID-To-Link Mapping Negotiation Support indicates what the STA that sent this frame supports for TID-to-link mapping negotiation. The TID-to-link mapping field contains a TID-to-link Mapping element that indicates TDLS direct link on which frames belonging to each TID can be exchanged.

### 9.5 TDLS Setup Response Frame

Table 4 depicts information for a TDLS Setup Response Action field into which new rows of information have been added. The TID-To-Link Mapping Negotiation Support indicates what the STA that sent this frame supports for TID-to-link mapping negotiation. The Status Code is used to indicate if the requested TID-to-Link mapping information as carried in the received TDLS Discovery request frame addressed to the receiver is accepted, or rejected, or if there is a suggested preferred mapping by the receiver. The TID-to-Link mapping information field contains TID-to-link Mapping element that indicates the preferred mapping on the TDLS direct link.

### 9.6 TWT Element

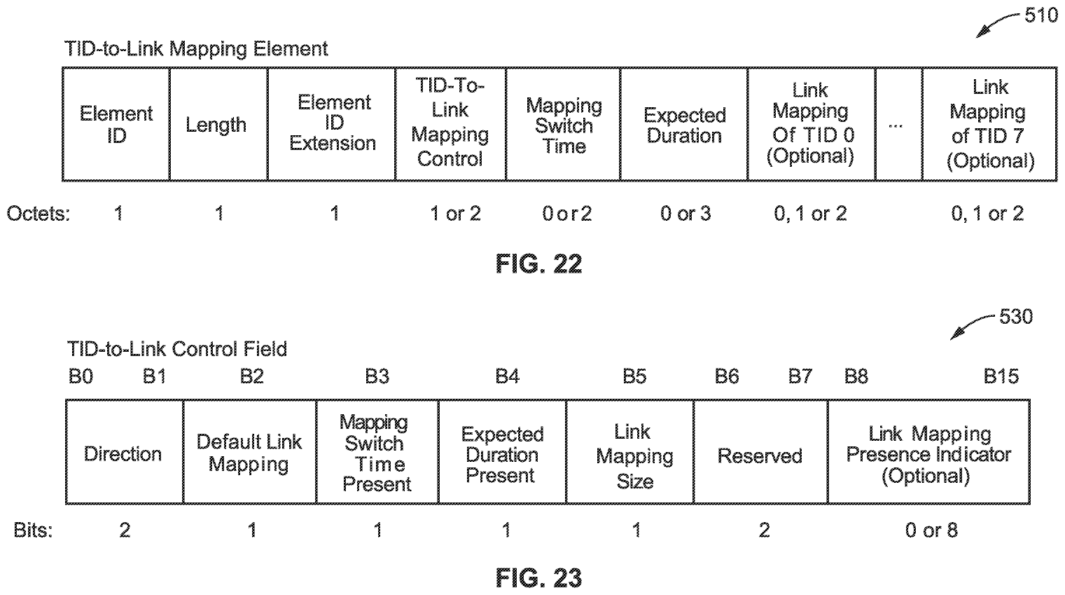

FIG. 24 illustrates a Restricted TWT P2P traffic information field 550, having the following subfields. A restricted TWT P2P TID bitmap subfield has been incorporated into this element, which already contained a traffic information control field, a restricted TWT DL TID bitmap subfield, and a restricted TWT UL TID bitmap.

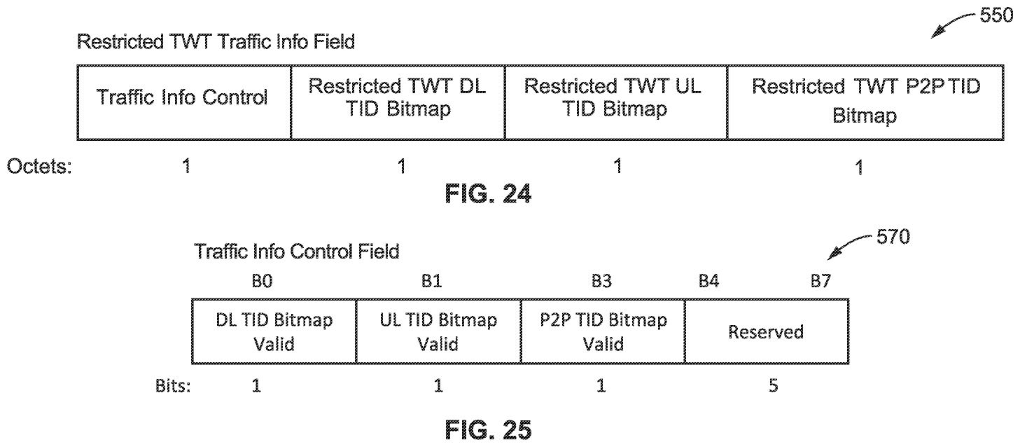

FIG. 25 illustrates the contents of the Traffic Information Control field as was shown in FIG. 24, which has the following subfields. A P2P TID Bitmap Valid subfield has been added into this field format which already contained a DL TID bitmap valid subfield, a UL TID bitmap valid subfield, and a reserved subfield.

The P2P TID Bitmap Valid subfield is set to a first state (e.g., “1”) to indicate that the Restricted TWT P2P TID Bitmap field is valid; otherwise, it is set to a second state (e.g., “0”) to indicate that the P2P traffic of all the TIDs mapped in the P2P link to the link in which the R-TWT membership is being setup, are identified as latency sensitive traffic, and the Restricted TWT P2P TID Bitmap field is reserved.

It should be appreciated that if R-TWT is not set up over a P2P direct link, and/or TID-to-link mapping isn't applied for P2P direct links, then the proposed frame format as defined in FIG. 24 and FIG. 25 are still necessary. For example, when a Triggered TXOP sharing procedure is utilized with Triggered TXOP Sharing Mode subfield value equal to ‘2’, for example the AP shares a portion of the TXOP with P2P transmission, that occurs within a R-TWT SP. Aside from only specifying the restricted TWT TIDs in UL and/or DL, the restricted TWT TIDs in the P2P direct link should also be specified to reduce the potential fairness issue. In this context, the P2P TID Bitmap Valid subfield is set to a first state (e.g., “1”) to indicate that the Restricted TWT P2P TID Bitmap field is valid. The P2P TID Bitmap Valid subfield being set to a second state (e.g., “0”) can have different interpretations: for example, it can indicate that the P2P traffic of all the TIDs is identified as latency sensitive traffic, or indicates that the P2P traffic of the TIDs that are same as all the TIDs mapped in the UL or DL to the link on which the R-TWT membership is indicated by the TWT element being setup is identified as latency sensitive traffic. The interpretations of these data field values can be application dependent. When the P2P TID Bitmap, Valid subfield is set to a second state (e.g., “0”), the Restricted TWT P2P TID Bitmap field is reserved.

The Restricted TWT P2P TID Bitmap subfield specifies the TID(s) that are identified by the R-TWT scheduling AP or the R-TWT scheduled STA as latency sensitive traffic streams in the P2P direction. If set to a first state (e.g., “1”) at bit position k in the bitmap this indicates that TID k is classified as a latency sensitive traffic stream; while this value is set to a second state (e.g., “0”) to indicate that TID k is not classified as a latency sensitive traffic stream.

The P2P TID Bitmap Valid subfield and the Restricted TWT Traffic Info field can be setup during either the procedure of R-TWT setup on P2P link as proposed in Section 7.1 or could be setup for the triggered TXOP enabled P2P transmission inside R-TWT SP as proposed in Section 7.2. In both cases, the P2P peer STAs shall follow the value as indicated in the P2P TID Bitmap Valid subfield and the Restricted TWT Traffic Info field as proposed in this section.

### 10. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for communication in a wireless network, the apparatus comprising: (a) at least one modem coupled to at least one radio-frequency (RF) circuit, with each RF circuit connected to one or multiple antennas; (b) wherein said station (STA) is a separate STA, or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA or a non-AP STA, for communicating with other STAs using a carrier sense multiple access/collision avoidance (CSMA/CA) mechanism; (e)(ii) mapping traffic identifiers (TIDs) to tunneled direct link setup (TDLS) direct links by extra high throughput (EHT) STAs is capable of following implementation; and (e)(iii) setting the direction subfield of the TID-To-Link control field of the TID-To-Link mapping element to a value which indicates that the TID-To-Link mapping element provides the TID-to-link mapping information for frames transmitted on the TDLS direct links.

An apparatus for communication in a wireless network, the apparatus comprising: (a) at least one modem coupled to at least one radio-frequency (RF) circuit, with each RF circuit connected to one or multiple antennas; (b) wherein said station (STA) is a separate STA, or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA or a non-AP STA, for communicating with other STAs using a carrier sense multiple access/collision avoidance (CSMA/CA) mechanism; (e)(ii) performing a negotiation of traffic identifier (TID)-to-link mapping for tunneled direct link setup (TDLS) direct link during a TDLS direct link setup.

A station apparatus for communication in a wireless network, the apparatus comprising: (a) at least one modem coupled to at least one radio-frequency (RF) circuit, with each RF circuit connected to one or multiple antennas; (b) wherein said station (STA) is a separate STA, or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA or a non-AP STA, for communicating with other STAs using a carrier sense multiple access/collision avoidance (CSMA/CA) mechanism; and (e)(ii) performing a negotiation of TID-to-link mapping for TDLS direct link after TDLS direct link setup as a negotiating initiator non-AP STA MLD which supports TID-to-link mapping sends an individually addressed TID-to-link mapping request frame to a P2P peer non-AP MLD that has indicated support of TID-to-link mapping negotiation.

A station apparatus for communication in a wireless network, the apparatus comprising: (a) at least one modem coupled to at least one radio-frequency (RF) circuit, with each RF circuit connected to one or multiple antennas; (b) wherein said station (STA) is a separate STA, or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA or a non-AP STA, for communicating with other STAs using a carrier sense multiple access/collision avoidance (CSMA/CA) mechanism; and (e)(ii) enabling R-TWT membership setup on TDLS link(s) with following implementations, comprising: (e)(ii)(A) adding a restricted TWT P2P TID bitmap field in the restricted TWT traffic Info field to specify the TID(s) that is identified by the R-TWT scheduling AP or the R-TWT scheduled STA as latency sensitive traffic streams in the P2P direction; and (e)(ii)(B) adding a P2P TID bitmap valid subfield in the traffic info control field to indicate if the restricted TWT P2P TID Bitmap field is valid.

A station apparatus for communication in a wireless network, the apparatus comprising: (a) at least one modem coupled to at least one radio-frequency (RF) circuit, with each RF circuit connected to one or multiple antennas; (b) wherein said station (STA) is a separate STA, or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol, comprising: (e)(i) wherein said STA operates in the wireless communications protocol as either an Access Point (AP) STA or a non-AP STA, for communicating with other STAs using a carrier sense multiple access/collision avoidance (CSMA/CA) mechanism; and (e)(ii) performing peer-to-peer (P2P) direct link transmissions in R-TWT SP, comprising either: (e)(ii)(A) adding a restricted target wake time (R-TWT) P2P traffic identifier (TID) bitmap field in the R-TWT traffic Info field to specify the TID(s) in the P2P direct link direction that is identified by the R-TWT scheduling AP or the R-TWT scheduled STA; and (e)(ii)(B) adding a P2P TID bitmap valid subfield in the traffic info control field to indicate if the restricted TWT P2P TID Bitmap field is valid.

An apparatus for communication in a wireless network in which EHT STAs are capable of mapping TID(s) to TDLS direct links by following implementation: (a) setting a Direction subfield of the TID-To-Link Control field of the TID-To-Link Mapping element to a value, such as 3, to indicate that the TID-To-Link Mapping element provides the TID-to-link mapping information for frames transmitted on the TDLS direct links; (b) in some instances indicating the capability of TID-To-Link Mapping Negotiation Support for TDLS direct link(s) with a signal design; and (c) using an under default mapping mode, in which all TIDs are mapped to all setup links for DL and UL and P2P, and all setup links are enabled.

An apparatus for communication in a wireless network in which the negotiation of TID-to-link mapping for TDLS direct link could be processed during TDLS direct link setup: (a) When negotiating TID-to-link mapping during single link TDLS direct link setup: (i) negotiating initiator EHT STA MLD may include TID-To-Link Mapping Negotiation Support and TID-to-Link mapping information in TDLS Discovery request frame and/or TDLS Setup Request frame, or any other frames sent to the associated AP MLD or to P2P peer non-AP MLD during TDLS setup; (A) wherein the TID-to-link mapping field contains TID-to-link Mapping element that indicates TDLS direct link on which frames belonging to each TID can be exchanged; (ii) wherein the peer non-AP MLD includes TID-To-Link Mapping Negotiation Support, Status Code and TID-to-Link mapping information in TDLS Discovery response frame, and/or TDLS Setup Response frame or any other frames sent back to the associated AP MLD or to the mapping initiator non-AP MLD during TDLS setup: (B) wherein the Status Code indicates the requested TID-to-Link mapping information as carried in the received TDLS Discovery/Setup request frame or other frames addressed to the receiver is accepted, or rejected, or suggestion made of a preferred mapping by the peer non-AP MLD; and (C) wherein the TID-to-Link mapping information indicates the preferred TID(s) mapping on the TDLS direct link; (iii) wherein in some cases the TID-To-Link Mapping Negotiation Support indicates that the peer non-AP MLD supports TID-to-link mapping negotiation; (iv) wherein in some cases the TID-To-Link Mapping negotiation is for single-link TDLS direct link; (b) wherein when negotiating TID-to-link mapping on multi-link TDLS direct links setup over a single link, some procedures are reused with an additional rule that the TID-To-Link Mapping negotiation is for multi-link TDLS direct links.

An apparatus for communication in a wireless network in which the negotiation of TID-to-link mapping for TDLS direct link can be processed after TDLS direct link setup: (a) wherein a negotiating initiator non-AP STA MLD that supports TID-to-link mapping sends an individually addressed TID-to-link Mapping Request frame to a P2P peer non-AP MLD that has indicated support of TID-to-link mapping negotiation; (b) wherein the exchange in supporting TID-to-link mapping negotiation is achieved during TDLS direct link setup, by including TID-To-Link Mapping Negotiation Support in the exchanged frames; (c) wherein the P2P peer non-AP MLD sends an individually addressed TID-to-link Mapping Response frame to the negotiating initiator non-AP STA MLD indicating if it accepts the requested TID-to-link mapping, or rejects the proposed TID-to-link mapping, or if it is suggesting a preferred mapping which is different from the requested TID-to-link mapping; (d) wherein the negotiating initiator non-AP STA MLD should take into account the preferred TID-to-link mapping of the peer MLD; and (e) wherein when two non-AP MLDs have negotiated a TID-to-link mapping, either MLD may tear down the negotiated P2P TID-to-link mapping by sending an individually addressed TID-To-Link Mapping Teardown frame; wherein after teardown, they shall operate in the default mapping mode.

An apparatus for communication in a wireless network in which R-TWT membership setup is enabled on TDLS link(s) comprising: (a) adding a Restricted TWT P2P TID Bitmap field in the Restricted TWT Traffic Info field to specify the TID(s) that is identified by the R-TWT scheduling AP or the R-TWT scheduled STA as latency sensitive traffic streams in the P2P direction; wherein a first value (e.g., ‘1’) at bit position k in the bitmap indicates that TID k is classified as latency sensitive traffic stream; whereby a second value (e.g., ‘0’) at bit position k in the bitmap indicates that TID k is not classified as latency sensitive traffic stream; (b) wherein a P2P TID Bitmap Valid subfield is added in the Traffic Info Control field to indicate if the Restricted TWT P2P TID Bitmap field is valid; and wherein it is set to a first state (e.g., ‘1’) to indicate that the Restricted TWT P2P TID Bitmap field is valid; wherein the P2P TID Bitmap Valid subfield is set to a second state (e.g., ‘0’) to indicate that the P2P traffic of all the TIDs mapped in the P2P link to the link in which the R-TWT membership is being setup, is identified as latency sensitive traffic, and the Restricted TWT P2P TID Bitmap field is reserved; (c) wherein the R-TWT requesting STA sends a R-TWT request frame to the associated AP and indicates the R-TWT SP is for certain TID(s) on an established P2P link with P2P peer STA; (d) wherein the TID(s) as negotiated for R-TWT are within the range of the TID(s) mapped to that P2P link; (e) wherein the R-TWT scheduling AP may send an unsolicited R-TWT response frame to the P2P peer STA to transfer the R-TWT requested/suggested schedule from the R-TWT requesting STA; (f) wherein the peer STA receives the unsolicited R-TWT response frame may accept the requested/suggested schedule by responding a R-TWT response frame indicates acceptance; or the peer STA may continue R-TWT negotiating with the R-TWT scheduling AP by transmitting R-TWT response frame with an indication of a different set of R-TWT parameters; or the peer STA may reject the requested/suggested schedule by responding with a R-TWT response frame which indicates rejection; (g) wherein the R-TWT scheduling AP should transfer the response from the peer STA to the R-TWT requesting STA; wherein the R-TWT requesting STA may update the negotiated R-TWT parameters based on the response from the R-TWT scheduling AP; and (h) wherein during the R-TWT SP on the P2P link, it is possible that both R-TWT requesting STA and its P2P peer STA are considered as R-TWT member STAs and can transmit the P2P traffic with the R-TWT TID to each other; wherein it is also possible that only the R-TWT requesting STA is considered as the R-TWT member STA and can thus transmit the P2P traffic with the R-TWT TID to the P2P peer STA.

The apparatus of any preceding implementation, further comprising performing a default mapping mode, in which all TIDs are mapped to all setup links for downlink (DL) and uplink (UL) and peer-to-peer (P2P), and all setup links are enabled.

The apparatus of any preceding implementation, further comprising signaling a capability for TID-To-Link mapping negotiation support for TDLS direct link(s) with a signal design.

The apparatus of any preceding implementation, further comprising negotiating of TID-to-link mapping during TDLS direct link setup by a negotiating initiator EHT STA MLD including TID-To-Link mapping negotiation support and TID-to-Link mapping information in a frame sent to the associated AP MLD or in peer-to-peer (P2P) mode to a peer non-AP MLD during TDLS setup.

The apparatus of any preceding implementation, wherein said TID-To-Link mapping negotiation support for TDLS direct link(s) and TID-to-Link mapping information is sent in a TDLS discovery request frame.

The apparatus of any preceding implementation, wherein said TID-To-Link mapping negotiation support for TDLS direct link(s) and TID-to-Link mapping information is sent in a TDLS setup request frame.

The apparatus of any preceding implementation, wherein the TID-to-link mapping field contains a TID-to-link mapping element that indicates a TDLS direct link on which frames belonging to each TID can be exchanged.

The apparatus of any preceding implementation, wherein said peer non-AP MLD contains TID-To-Link mapping negotiation support, status code and TID-to-Link mapping information.

The apparatus of any preceding implementation, wherein said TID-To-Link mapping negotiation support, status code and TID-to-Link mapping information is contained in a TDLS discovery response frame, and/or a TDLS setup response frame or other frames sent back to the associated AP MLD or to the mapping initiator non-AP MLD during TDLS setup.

The apparatus of any preceding implementation, wherein the status code indicates the requested TID-to-Link mapping information as carried in frames addressed to the receiver, which can be is accepted, or rejected, or a suggested preferred mapping supplied by the peer non-AP MLD.

The apparatus of any preceding implementation, wherein the TID-to-Link mapping information is carried in a received TDLS discovery or setup request frame, or other frames addressed to the receiver.

The apparatus of any preceding implementation, wherein the TID-to-Link mapping information indicates the preferred TID(s) mapping on the TDLS direct link.

The apparatus of any preceding implementation, wherein the exchange in supporting TID-to-link mapping negotiation is performed during a TDLS direct link setup and includes TID-To-Link mapping negotiation support in the exchanged frames.

The apparatus of any preceding implementation, wherein the P2P peer non-AP MLD sends an individually addressed TID-to-link mapping response frame to the negotiating initiator non-AP STA MLD indicating if it accepts the requested TID-to-link mapping, or rejects the proposed TID-to-link mapping, or suggests a preferred mapping which is different from the requested TID-to-link mapping.

The apparatus of any preceding implementation, wherein the negotiating initiator non-AP STA MLD considers whether to accept the preferred TID-to-link mapping of the peer MLD.

The apparatus of any preceding implementation, wherein upon two non-AP MLDs having negotiated a TID-to-link mapping, in which either MLD can tear down the negotiated P2P TID-to-link mapping by sending an individually addressed TID-To-Link mapping teardown frame, wherein after teardown, they operate in the default mapping mode.

The apparatus of any preceding implementation, wherein an R-TWT requesting STA sends a R-TWT request frame to the associated AP and indicates the R-TWT SP is for certain TID(s) on an established P2P link with P2P peer STA.

The apparatus of any preceding implementation, wherein the TID(s) as negotiated for R-TWT are within the range of the TID(s) mapped to that P2P link.

The apparatus of any preceding implementation, wherein an R-TWT scheduling AP sends an unsolicited R-TWT response frame to the P2P peer STA to transfer R-TWT requested or suggested schedule from the R-TWT requesting STA.

The apparatus of any preceding implementation, wherein a peer STA receives the unsolicited R-TWT response frame and determines whether to accept the requested or suggested schedule by responding with a R-TWT response frame indicating acceptance; or the peer STA continues R-TWT negotiations with the R-TWT scheduling AP by transmitting a R-TWT response frame indicating a different set of R-TWT parameters; or the peer STA rejects the requested or suggested schedule by responding with a R-TWT response frame that indicates rejection.

The apparatus of any preceding implementation, wherein the R-TWT scheduling AP transfers the response from the peer STA to the R-TWT requesting STA.

The apparatus of any preceding implementation, wherein the R-TWT requesting STA updates negotiated R-TWT parameters based on what response is received from the R-TWT scheduling AP.

The apparatus of any preceding implementation, wherein the R-TWT requesting STA exchanges the TDLS setup request frame and TDLS setup response frame with the P2P peer STA through affiliated AP to set up the R-TWT SP for the P2P transmission.

The apparatus of any preceding implementation, wherein the TDLS setup request frame and TDLS setup response frame carry the information of a TWT element in which the negotiation type subfield of the TWT element are set to a value of ‘2’ and/or ‘3’.

The apparatus of any preceding implementation, wherein during the R-TWT SP on the P2P link, if it is determined that both the R-TWT requesting STA and its P2P peer STA are considered as R-TWT member STAs, then they are allowed to transmit P2P traffic with the R-TWT TID to each other.

The apparatus of any preceding implementation, wherein during the R-TWT SP on the P2P link, if it is determined that only the R-TWT requesting STA is considered as the R-TWT member STA, then it is allowed to transmit the P2P traffic with the R-TWT TID to the P2P peer STA.

The apparatus of any preceding implementation, wherein The P2P TID bitmap valid subfield indicates an invalid value when either: (A) the P2P traffic of all the TIDs is identified as latency sensitive traffic; or (B) the P2P traffic of the TIDs that are same as all the TIDs mapped in the UL or DL to the link on which the R-TWT membership indicated by the TWT element is being setup is identified as latency sensitive traffic.

The apparatus of any preceding implementation, wherein the P2P TID bitmap valid subfield indicates an invalid value when the R-TWT P2P TID bitmap field is reserved.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%. For example, “substantially” aligned can refer to a range of angular variation of less than or equal to +10°, such as less than or equal to +5°, less than or equal to +4°, less than or equal to +3º, less than or equal to +2°, less than or equal to +1°, less than or equal to +0.5°, less than or equal to +0.1°, or less than or equal to +0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
TDLS Discovery Request Action Field

| Order | Information |
|---|---|
| <Last assigned + 1> | TID-To-Link Mapping Negotiation Support |
| <Last assigned + 2> | TID-To-Link Mapping |

TABLE 2
TDLS Discovery Response Frame

| Order | Information |
|---|---|
| <Last assigned + 1> | TID-To-Link Mapping Negotiation Support |
| <Last assigned + 2> | Status Code |
| <Last assigned + 3> | TID-To-Link Mapping |

TABLE 3
TDLS Setup Request Action Field

| Order | Information |
|---|---|
| <Last assigned + 1> | TID-To-Link Mapping Negotiation Support |
| <Last assigned + 2> | TID-To-Link Mapping |

TABLE 4
TDLS Setup Response Frame

| Order | Information |
|---|---|
| <Last assigned + 1> | TID-To-Link Mapping Negotiation Support |
| <Last assigned + 2> | Status Code |
| <Last assigned + 3> | TID-To-Link Mapping |

What is claimed is:

1. An apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism;
(ii) mapping traffic identifiers (TIDs) to tunneled direct link setup (TDLS) direct links by extra high throughput (EHT) STAs is capable of following implementation; and
(iii) setting the direction subfield of the TID-To-Link control field of the TID-To-Link mapping element to a value which indicates that the TID-To-Link mapping element provides the TID-to-link mapping information for frames transmitted on the TDLS direct links.

2. The apparatus of claim 1, further comprising performing a default mapping mode, in which all TIDs are mapped to all setup links for downlink (DL) and uplink (UL) and peer-to-peer (P2P), and all setup links are enabled.

3. The apparatus of claim 1, further comprising signaling a capability for TID-To-Link mapping negotiation support for TDLS direct link(s) with a signal design.

4. An apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism; and
(ii) performing a negotiation of traffic identifier (TID)-to-link mapping for tunneled direct link setup (TDLS) direct link during a TDLS direct link setup.

5. The apparatus of claim 4, further comprising negotiating of TID-to-link mapping during TDLS direct link setup by a negotiating initiator EHT STA MLD including TID-To-Link mapping negotiation support and TID-to-Link mapping information in a frame sent to the associated AP MLD, or in peer-to-peer (P2P) mode to a peer non-AP MLD during TDLS setup.

6. The apparatus of claim 5, wherein said TID-To-Link mapping negotiation support for TDLS direct link(s) and TID-to-Link mapping information is sent in a TDLS discovery request frame.

7. The apparatus of claim 5, wherein said TID-To-Link mapping negotiation support for TDLS direct link(s) and TID-to-Link mapping information is sent in a TDLS setup request frame.

8. The apparatus of claim 4, wherein the TID-to-link mapping field contains a TID-to-link mapping element that indicates a TDLS direct link on which frames belonging to each TID can be exchanged.

9. The apparatus of claim 4, wherein said peer non-AP MLD contains TID-To-Link mapping negotiation support, status code and TID-to-Link mapping information.

10. The apparatus of claim 9, wherein said TID-To-Link mapping negotiation support, status code and TID-to-Link mapping information is contained in a TDLS discovery response frame, and/or a TDLS Setup Response frame, or other frames sent back to the associated AP MLD or to the mapping initiator non-AP MLD during TDLS setup.

11. The apparatus of claim 10, wherein the status code indicates the requested TID-to-Link mapping information as carried in frames addressed to the receiver, which can be accepted, or rejected, or a suggested preferred mapping supplied by the peer non-AP MLD.

12. The apparatus of claim 11, wherein the TID-to-Link mapping information is carried in a received TDLS discovery or setup request frame, or other frames addressed to the receiver.

13. The apparatus of claim 4, wherein the TID-to-Link mapping information indicates the preferred TID(s) mapping on the TDLS direct link.

14. A station apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism; and
(ii) performing a negotiation of TID-to-link mapping for TDLS direct link after TDLS direct link setup as a negotiating initiator non-AP STA MLD which supports TID-to-link mapping and sends an individually addressed TID-to-link mapping request frame to a P2P peer non-AP MLD that has indicated support of TID-to-link mapping negotiation.

15. The apparatus of claim 14, wherein the exchange in supporting TID-to-link mapping negotiation is performed during a TDLS direct link setup and includes TID-To-Link mapping negotiation support in the exchanged frames.

16. The apparatus of claim 14, wherein the P2P peer non-AP MLD sends an individually addressed TID-to-link mapping response frame to the negotiating initiator non-AP STA MLD indicating if it accepts the requested TID-to-link mapping, or rejects the proposed TID-to-link mapping, or suggests a preferred mapping which is different from the requested TID-to-link mapping.

17. The apparatus of claim 14, wherein the negotiating initiator non-AP STA MLD considers whether to accept the preferred TID-to-link mapping of the peer MLD.

18. The apparatus of claim 14, wherein upon two non-AP MLDs having negotiated a TID-to-link mapping, in which either MLD can tear down the negotiated P2P TID-to-link mapping by sending an individually addressed TID-To-Link Mapping Teardown frame, wherein after teardown, the MLDs operate in the default mapping mode.

19. A station apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism; and
(ii) enabling R-TWT membership setup on TDLS link(s) with following implementations, comprising:
(A) adding a restricted TWT P2P TID bitmap field in the restricted TWT traffic Info field to specify the TID(s) that is identified by the R-TWT scheduling AP or the R-TWT scheduled STA as latency sensitive traffic streams in the P2P direction; and
(B) adding a P2P TID bitmap valid subfield in the traffic info control field to indicate if the restricted TWT P2P TID Bitmap field is valid.

20. The apparatus of claim 19, wherein an R-TWT requesting STA sends a R-TWT request frame to the associated AP and indicates the R-TWT SP is for certain TID(s) on an established P2P link with P2P peer STA.

21. The apparatus of claim 19, wherein the TID(s) as negotiated for R-TWT are within the range of the TID(s) mapped to that P2P link.

22. The apparatus of claim 19, wherein an R-TWT scheduling AP sends an unsolicited R-TWT response frame to the P2P peer STA to transfer a requested or suggested R-TWT schedule from the R-TWT requesting STA.

23. The apparatus of claim 22, wherein a peer STA receives the unsolicited R-TWT response frame and determines whether to accept the requested or suggested schedule by responding with a R-TWT response frame indicating acceptance; or the peer STA continues R-TWT negotiations with the R-TWT scheduling AP by transmitting a R-TWT response frame indicating a different set of R-TWT parameters; or the peer STA rejects the requested or suggested schedule by responding with a R-TWT response frame that indicates rejection.

24. The apparatus of claim 23, wherein the R-TWT scheduling AP transfers the response from the peer STA to the R-TWT requesting STA.

25. The apparatus of claim 24, wherein the R-TWT requesting STA updates negotiated R-TWT parameters based on what response is received from the R-TWT scheduling AP.

26. The apparatus of claim 19, wherein the R-TWT requesting STA exchanges the TDLS setup request frame and TDLS setup response frame with the P2P peer STA through its affiliated AP to setup the R-TWT SP for the P2P transmission.

27. The apparatus of claim 26, wherein the TDLS setup request frame and TDLS setup response frame carry the information about TWT element in which the negotiation type subfield of the TWT element are set to a value of ‘2’ and/or ‘3’.

28. The apparatus of claim 19, wherein during the R-TWT SP on the P2P link, if it is determined that both the R-TWT requesting STA and its P2P peer STA are considered as R-TWT member STAs, then they are allowed to transmit P2P traffic with the R-TWT TID to each other.

29. The apparatus of claim 19, wherein during the R-TWT SP on the P2P link, if it is determined that only the R-TWT requesting STA is considered as the R-TWT member STA, then it is allowed to transmit the P2P traffic with the R-TWT TID to the P2P peer STA.

30. A station apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism; and
(ii) supporting a triggered TXOP sharing procedure enabled P2P transmission inside an R-TWT SP;
(iii) performing peer-to-peer (P2P) direct link transmissions in R-TWT SP, comprising either:
(A) adding a restricted target wake time (R-TWT) P2P traffic identifier (TID) bitmap field in the R-TWT traffic information field to specify the TID(s) in the P2P direct link direction that is identified by the R-TWT scheduling AP or the R-TWT scheduled STA; and
(B) adding a P2P TID bitmap valid subfield in the traffic information control field to indicate if the restricted TWT P2P TID bitmap field is valid.

31. The apparatus of claim 30, wherein The P2P TID bitmap valid subfield indicates an invalid value when either: (A) the P2P traffic of all the TIDs is identified as latency sensitive traffic; or (B) the P2P traffic of the TIDs that are the same as all the TIDs mapped in the UL or DL to the link on which the R-TWT membership indicated by the TWT element is being setup is identified as latency sensitive traffic.

32. The apparatus of claim 30, wherein the P2P TID bitmap valid subfield indicates an invalid value when the R-TWT P2P TID bitmap field is reserved.

33. The apparatus of claim 30, wherein the said STA could indicate the feature of supporting triggered TXOP sharing procedure enabled P2P transmission inside R-TWT SP by setting a new designed attribute value to true.

34. The apparatus of claim 31, wherein the said STA setting the new designed attribute value to true, and its P2P peer STA shall follow the value as indicated in the P2P TID Bitmap Valid subfield and the Restricted TWT Traffic Info field.

35. A station apparatus for communication in a wireless network, the apparatus comprising:
(a) at least one modem coupled to at least one radio-frequency (RF) circuit, with each RF circuit connected to one or multiple antennas;
(b) wherein said station (STA) is a separate STA, or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol, comprising:
(i) wherein said STA operates in the wireless communications protocol as either an Access Point (AP) STA or a non-AP STA, for communicating with other STAs using a carrier sense multiple access/collision avoidance (CSMA/CA) mechanism; and
(ii) wherein said wireless communication protocol does not allow triggered TXOP sharing procedure to enable P2P transmission inside an R-TWT SP.

36. The apparatus of claim 35, wherein said STA indicates the feature of not supporting triggered TXOP sharing procedure enabled P2P transmission inside R-TWT SP by setting a newly designated attribute value to false.
